(19) United States
(12) Patent Application Publication
(10) Pub. No.: US 2008/0137814 A1
(43) Pub. Date: Jun. 12, 2008

(54) Systems and Methods for Replaying Recorded Data

(76) Inventors: Jamie Richard Williams, Fleet (GB); Marc Calahan, Woodstock, GA (US); Robert John Barnes, Watford Herts (GB)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/831,634

(22) Filed: Jul. 31, 2007

Related U.S. Application Data
(63) Continuation-in-part of application No. 11/567,852, filed on Dec. 7, 2006.

(51) Int. Cl. H04M 1/00

(52) U.S. Cl. 379/67.1

(57) ABSTRACT

It should be emphasized that the above Systems and methods for replaying recorded data are provided. An exemplary embodiment of such a system comprises: at least one of a phone and a computing device being configured to instruct a recording system to replay recorded data; and a recording system being configured to communicate with the at least one of the phone and the computing device, the recording system being further configured to facilitate establishing a first session to replay the recorded data, the recording system being further configured to replay the recorded data to the at least one of the phone and the computing device using the established first session.

### CROSS-REFERENCE TO RELATED APPLICATION

This application is a continuation-in-part of copending U.S. utility application entitled, “Call Control Recording,” having Ser. No. 11/567,852, filed Dec. 07, 2006, which is entirely incorporated herein by reference.

### TECHNICAL FIELD

The present disclosure is generally related to replaying recorded data.

### BACKGROUND

A telephony system, such as used in a trading room, supports a range of equipment. By way of example, at each trader's desk of a trading room, such equipment can include up to four telephony handsets, up to 32 loudspeaker channels, and up to two microphones. Unfortunately, disputes can arise in a trading room due to over-hearing and/or mis-hearing of communications provided by such equipment. The availability and quality of recordings of such communications, therefore, can be critical to resolving these disputes.

In a compliance-recording environment, it can be imperative that everything that could have been heard, and therefore acted upon, is recorded and can be replayed. This can include recording speech that was not originally intended for the handset/microphone from which the speech was heard. For instance, recording should be able to accommodate a situation in which a trader hears “buy” even though the communication was being shouted into another handset. During the communication, a client may indicate how many shares to buy at a certain price. The trader can replay the recorded communication to be certain of the number of shares and price before acting on that communication.

### SUMMARY

In this regard, systems and methods for replaying recorded data are provided. An exemplary embodiment of such a system comprises: at least one of a phone and a computing device being configured to instruct a recording system to replay recorded data; and a recording system being configured to communicate with the at least one of the phone and the computing device, the recording system being further configured to facilitate establishing a first session to replay the recorded data, the recording system being further configured to replay the recorded data to the at least one of the phone and the computing device using the established first session.

An exemplary embodiment of a method comprises: instructing a recording system to replay recorded data to at least one of a phone and a computing device; establishing a first session to replay the recorded data; and replaying by the recording system the recorded data to the at least one of the phone and the computing device using the established first session.

Other systems, methods, features, and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

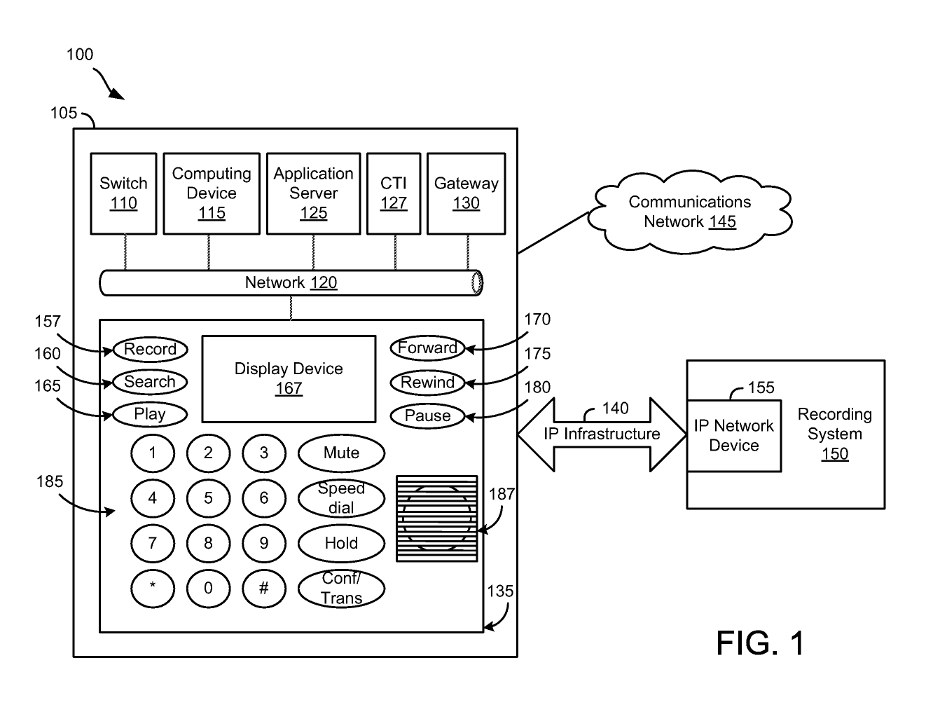

FIG. 1 is a block diagram of an embodiment of a system in which a recording system can replay recorded data to a customer center;

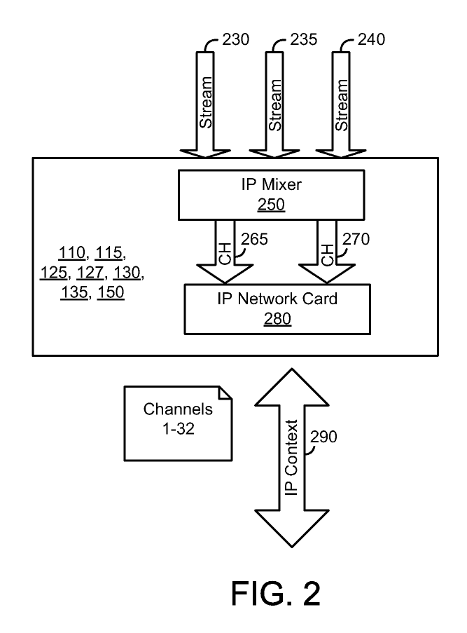

FIG. 2 is a block diagram that illustrates an embodiment of a switch, computing device, application server, computer telephony integration, gateway, phone and recording system, such as that shown in FIG. 1, having an IP network card;

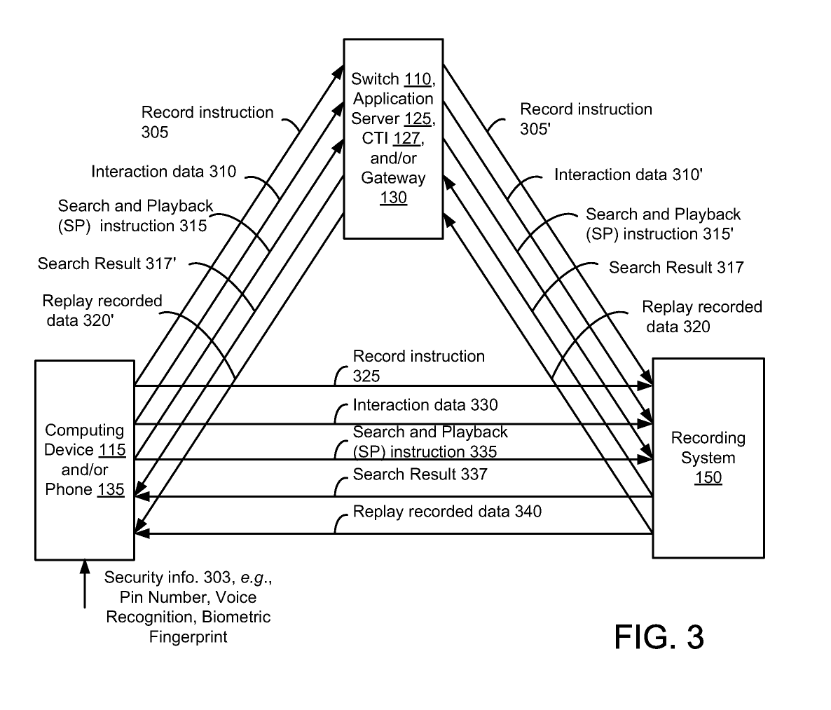

FIG. 3 is a block diagram that illustrates an embodiment of a communication process between the customer center and the recording system, such as that shown in FIG. 1;

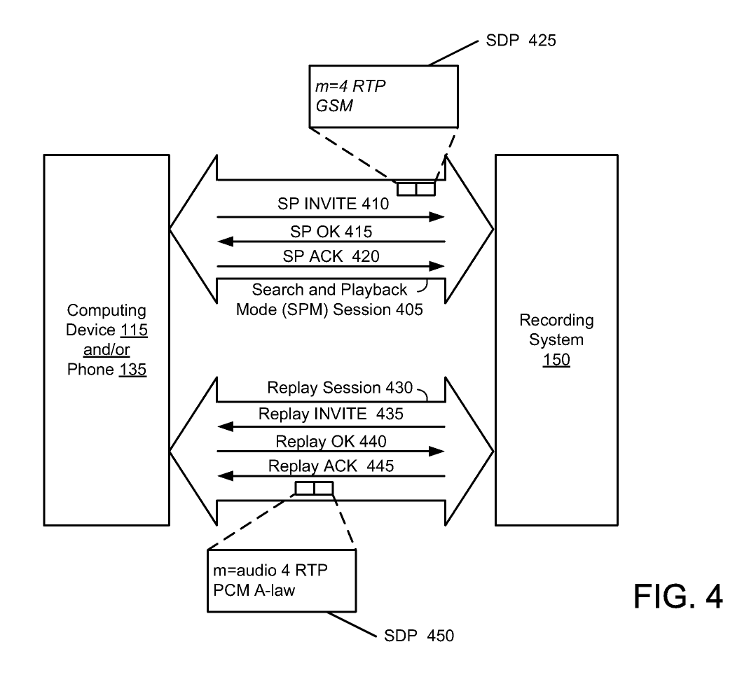

FIG. 4 is a block diagram that illustrates an embodiment of session establishment processes for replaying data recorded at the recording system, such as that shown in FIG. 1;

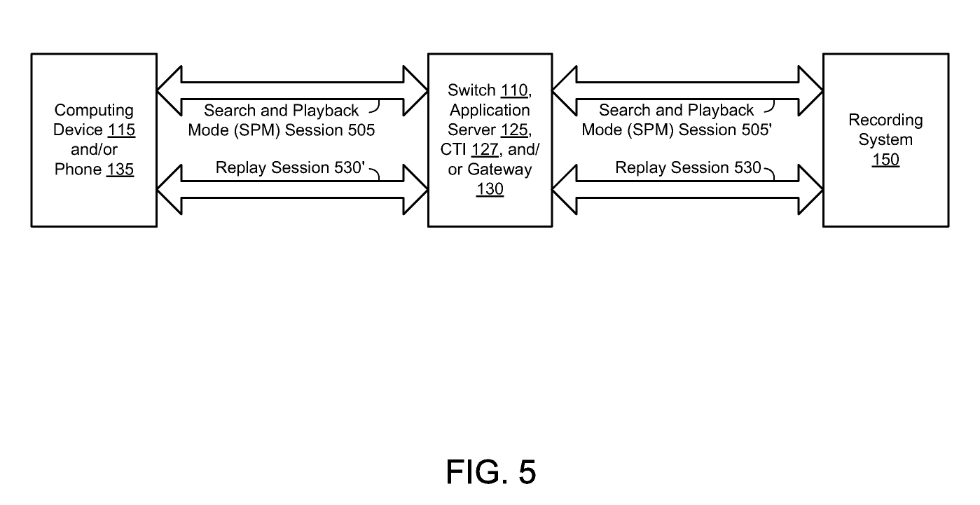

FIG. 5 is a block diagram that illustrates an embodiment of sessions among the switch, computing device, application server, computer telephony integration, gateway, phone, and recording system for replaying data recorded at the recording system, such as that shown in FIG. 1;

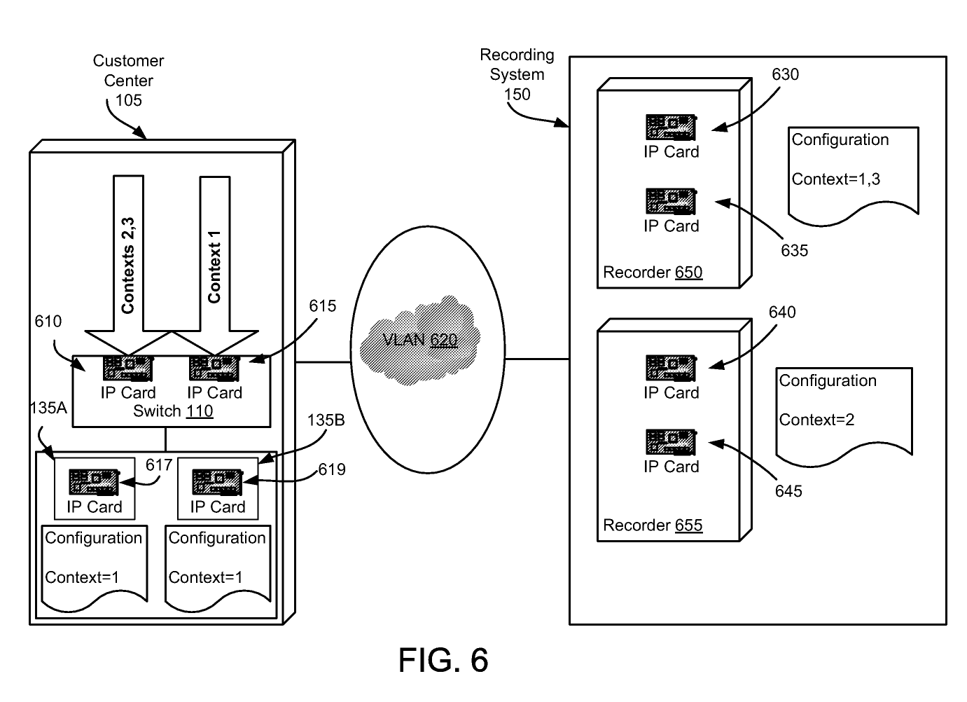

FIG. 6 is a block diagram of an embodiment of the customer center and the recording system, such as that shown in FIG. 1, each having an Internet protocol (IP) card that is utilized to facilitate replaying data recorded at the recording system;

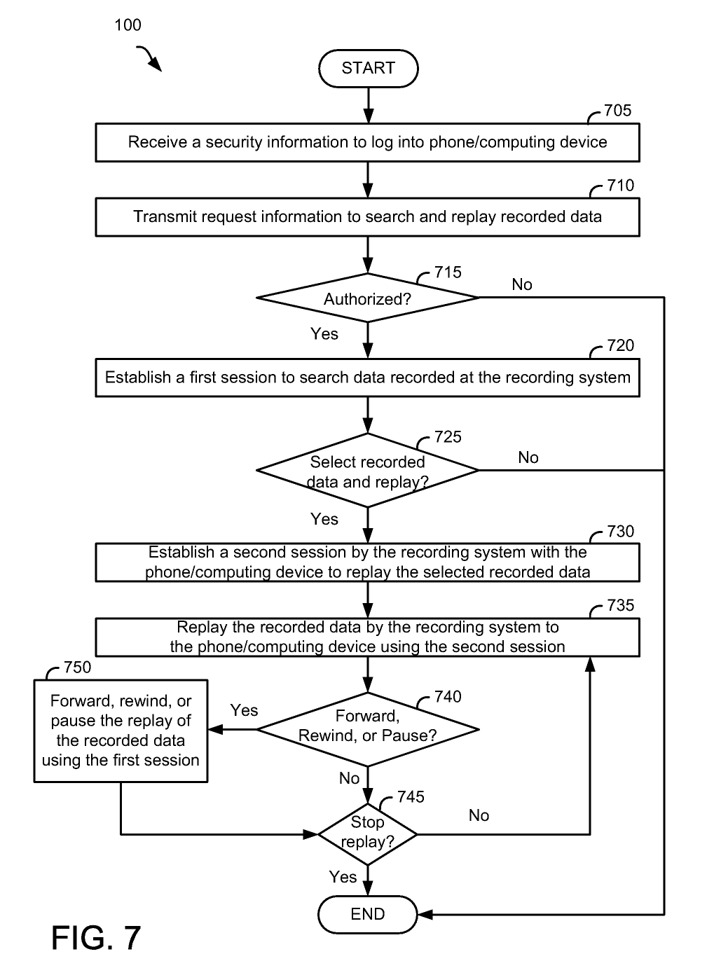

FIG. 7 is flow diagram that illustrates operation of an embodiment of the system, such as that shown in FIG. 1, that searches and replays data recorded at the recording system; and

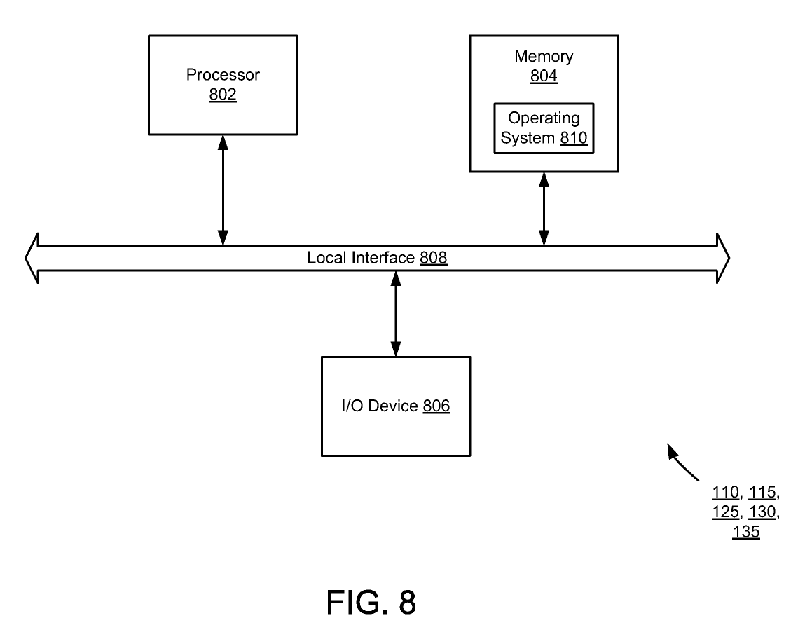

FIG. 8 is a block diagram that illustrates an embodiment of each of a switch, computing device, application server, computer telephony integration, gateway, phone and recording system, such as that shown in FIG. 1.

### DETAILED DESCRIPTION

Disclosed herein are systems and methods for replaying data recorded at a recording system. In particular, embodiments of such a system establish at least one session to replay the data recorded at the recording system. The recording system can be deployed at a centralized location, e.g., within a company premises, and/or embedded into a network as a service on the network and/or as intelligence in the network infrastructure.

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which the recorded data can be replayed.

FIG. 1 is a block diagram of an embodiment of a system 100 in which a recording system 150 can replay recorded data to a customer center 105. As indicated in this figure, the system 100 comprises the customer center 105 that includes a customer center switch 110, computing device 115, application server 125, computer telephony integration (CTI) 127, gateway 130 and phone 135, all of which are connected to a customer center network 120.

The phone 135 includes, but is not limited to, a turret phone, soft phone and Internet Protocol (IP) phone, among others. The phone 135 includes keypads 185, speaker 187, and a display device 167. The phone 135 further includes a record button 157 for recording communications at the phone 135, a search button 160 for searching data recorded at the recording system 150, and playback buttons, such as, play 165, forward 170, rewind 175, and pause 180, among others, for playing back the recorded data. The search and playback functionalities for audio that is recorded at the recording system 150 are further described in relation to FIGS. 3 and 7. It should be noted that the computing device 115 can also have search and playback functionalities similar to the phone 135 for screen capture and text message that are recorded at the recording system 150. Alternatively or addition, if the phone 135 is a video phone, the phone 135 can replay screens as video images. The video phone can also have playback controls of the replay of the recorded data, display images during interactions, and receive and generate meta-data associated with the recording or transcripts of the interactions.

Incoming communications from a communications network 145 can be routed to the switch 110, which can route the communications to the computing device 115 and/or phone 135. The communication network 145 can be a Public Switch Telephony Network (PSTN) and/or IP-based network, among others. The incoming communications can include, but are not limited to, voice, text, and video communications, among others. The customer center network 120 can include, but is not limited to, a wide area network (WAN), a local area network (LAN), a virtual private network (VPN) and the Internet.

The switch 110 is operative to process the communications at the customer center 105 and transmit the communications to a recording system 150 via, for example, an IP infrastructure 140, among others. An embodiment of the switch 110, computing device 115, application server 125, CTI 127, gateway 130, and phone 135 is further described in relation to FIGS. 2 and 8.

The IP infrastructure 140 of the customer center 105 can include, but is not limited to, a Pseudowire Emulation Edge to Edge (PWE3) protocol, Session Initiation Protocol (SIP), and Real-Time Transport Protocol (RTP), among others. The objective of PWE3 protocol is to support many Layer 1 and Layer 2 services over a common packet switched network (PSN) infrastructure. The Layer 1 and Layer 2 services include, but are not limited to, frame relay, Ethernet, Asynchronous Transfer Mode (ATM), Synchronous Optical Network (SONET), and Time Division Multiplexing (TDM).

The PWE3 protocol defines a framework and architecture with particular requirements to satisfy the service-specific protocol that defines how each Layer 1 or Layer 2 is encapsulated in PSN frames. Examples of PSN include, but are not limited to, MultiProtocol Label Switching (MPLS), Internet Protocol (IP) such as RTP, IPv4, or IPv6, and Layer 2 Tunneling Protocol (L2TP). The PWE 3 protocol also defines a control protocol to establish connectivity across the PSN.

The recording system 150 abstracts information related to the IP infrastructures 140 via an IP network device 155, e.g., a Network Interface Card (NIC) and an Internet Protocol Switch Interface (IPSI) card, among others. Included in this disclosure are embodiments of capturing communications data, as discussed in U.S. patent application Ser. No. 11/693,814, filed on Mar. 30, 2007, entitled “Systems and Methods for Capturing Communications Data,” which is hereby incorporated by reference in its entirety.

FIG. 2 is a block diagram that illustrates an embodiment of a switch 110, computing device 115, application server 125, computer telephony integration 127, gateway 130, phone 135, and recording system 150, such as that shown in FIG. 1, having an IP network card. The electrical components 110, 115, 125, 130, 135, 150 each can include an IP mixer 250, which is operative to receive IP streams 230, 235, 240, and mix the IP streams 230, 235, 240 in various combinations. In this example, the IP mixer 250 mixes the streams 235, 240 and transmits the mixed streams 235, 240 on channel 265, and the stream 230, which is not mixed with the other IP streams, is processed and transmitted on channel 270. The channels 265, 270 are transmitted to an IP network card 280, e.g., an Internet Protocol Switch Interface (IPSI) card, which transmits the channels on an IP context 290 to the recording system 150. Each context is similar to a single PCM32 span and can have approximately 32 or more channels. A single IP network card 280 may have one or more contexts. In general, the IP network card 280 is a hardware device designed to allow devices to communicate over a computer network. The IP network card 280 is both an OSI layer 1 (physical layer) and layer 2 (data link layer) device, which provide physical access to a networking medium and provide a low-level addressing system through the use of MAC addresses. In one example, the IP network card 280 can be a hardware device on a Telephony Relay Service (TRS) backplane that communicates between the TRS system and IP-based phones and/or recorders. Alternatively or additionally, the IP network card 280 can be a dual-purpose IPSI card that communicates with both phones and recorders, or a special purpose version of the card that communicates only with recorders. The IP network card 280 can use PWE3 protocol or any other IP protocol to transmit voice to/from IP-based phones.

FIG. 3 is a block diagram that illustrates an embodiment of a communication process between the customer center 105 and the recording system 150, such as that shown in FIG. 1. The computing device 115 and/or phone 135 can receive security information to facilitate a user logging into a customer center's network. The security information includes, but is not limited to a pin number, voice recognition, and biometric fingerprint, among others.

The computing device 115 and/or phone 135 can directly send a record instruction 325, search and playback instruction (SP) 335 and interaction data 330 to the recording system 150. Alternatively or additionally, the computing device 115 and/or phone 135 can send a record instruction 305, search and playback (SP) instruction 315 and interaction data 310 to the recording system 150 via, for example, the switch 10, application server 125, CTI 127, and/or gateway 130, among others.

The computing device 115 and/or phone 135 can instruct the recording system 150 to record the interaction data 330 via the record instruction 325. Alternatively or additionally, the switch 110, the application server 125, the CTI 127, and the gateway 130 can also instruct the recording system 150 to record the interaction data 310 from the computing device 115 and/or phone 135. The computing device 115 and/or phone 135 can send the search and playback instruction 315, 335 to the recording system 150 for searching and replaying the recorded data. Responsive to receiving the search and playback instruction 315, 335, the recording system 150 transmits the search result 317, 337 and replays the recorded data 320, 320′, 340 to the computing device 115 and/or phone 135.

FIG. 4 is a block diagram that illustrates an embodiment of session establishment processes for replaying recorded data at a recording system 150, such as that shown in FIG. 1. A SIP session can occur between the recording system 150 and the computing device 115 and/or phone 135 on a channel of the IP context 290 (FIG. 2). The recording system 150, computing device 115 and phone 135 are identified by IP addresses and/or ports contained in the SIP message.

A search and playback mode (SPM) session 405 can be established beginning with the computing device 115 and/or phone 135 sending an Invite request 410 to the recording system 150 for searching and playing back (SP) the data recorded at the recording system 150. The Invite request 410 invites the recording system 150 to participate in a session. The recording system 150 sends one or more responses (positive, negative or provisional) back to the computing device 115 and/or phone 135. In the example of FIG. 4, the recording system 150 sends an SP OK response 415, which is a final positive response. Responsive to receiving the SP Ok response 415, the computing device 115 and/or phone 135 send an SP ACK response 420 for confirming that the computing device 115 and/or phone 135 has received the SP OK response 415 to the SP Invite 410 request.

Both SP Invite 410 and the SP OK response 415 can include a Session Description Protocol (SDP) portion 425 which describes various features of SP Invite 410, including a media specification. The media specification in the SP Invite 410 identifies codecs (e.g., GSM, G.721, G.729, etc.) that the SP Invite 410 is capable of using during the SPM session 405. It should be noted that the SDP portion 425 uses RTP payload types, which are mapped to codecs. For clarity, the term “codec” will be used rather than RTP payload type. Both SP Invite 410 and the SP OK response 415 can use the media specification to negotiate a list of codecs which can be used on the SPM session 405.

The SP Invite 410 presents a list of codecs supported by the computing device 115 and/or phone 135. A positive SP OK response 415 from the recording system 150 includes at least one of the codecs listed by the computing device 115 and/or phone 135 that is supported by the recording system 150. Thus, the recording system 150 can remove unsupported codecs from the list, but cannot add a codec not listed in the original SP Invite 410.

The final step in the session establishment occurs when the computing device 115 and/or phone 135 accepts the codec listed in the SP OK response 415. The computing device 115 and/or phone 135 indicates acceptance by sending the SP ACK response 420. Alternatively or additionally, the search and playback mode session 405 can be initiated by a third party, such as, the switch 110, application server 125, CTI 127, and gateway 130, among others. Alternatively or additionally, the search and playback mode session 405 can be established using a proprietary protocol or webserver.

Replay session 430 is established similarly to the SPM session 405 described above and therefore includes a replay Invite request 435 for requesting to replay the data recorded at the recording system 150, a replay OK response 440 for accepting the request to replay the data recorded at the recording system 150, and a replay ACK response 445 for confirming that the computing device 115 and/or phone 135 has received the replay OK response 440 to the replay Invite request 435. Both the replay Invite 430 and the replay OK response 415 can include a Session Description Protocol (SDP) portion 450 which describes various features of replay Invite 435, including a media specification. The media specification in the replay Invite 435 identifies codecs (e.g., PCM A-law, PCM u-law, etc.) that the replay Invite 435 is capable of using during the replay session 430.

The recorded data includes, but is not limited to, media data and meta data associated with the recorded data, among others. The media data includes, but is not limited to, audio, text, and video. The meta data includes, but is not limited to, automatic number identification (ANI), dialed number identification service, and called party data. It should be noted that other protocols, such as, RTP and PWE3, can be used on the SPM session 405 and replay session 430 other than SIP. Alternatively or additionally, at least one session can use a different protocol than another session. For example, the SPM session 405 uses SIP while the replay session 430 uses PWE3.

FIG. 5 is a block diagram that illustrates an embodiment of sessions established among the switch 110, computing device 115, application server 125, CTI 127, gateway 130, and phone 135 for replaying data recorded at the recording system 150, such as that shown in FIG. 1. In this example, the computing device 115 and/or phone 135 do not communicate directly with the recording system 150. Instead, the switch 110, application server 125, CTI 127, and/or gateway 130 act as an intermediary between the two endpoints 115/135 and 150. Specifically, the switch 110, application server 125, CTI 127, and/or gateway 130 act as a SIP Back-to-Back User Agent (B2BUA). This intermediate position allows the switch 110, application server 125, CTI 127, and/or gateway 130 to perform functions such as network address translation (NAT), session and media routing, and transcoding. Alternatively or additionally, at least one session can use a different protocol than another session. For example, the SPM session 505 uses proprietary protocol; the SPM and relay sessions 505′, 530 use SIP; and the replay session 530′ uses PWE3.

FIG. 6 is a block diagram of an embodiment of the customer center 105 and the recording system 150, such as that shown in FIG. 1, each having an Internet protocol (IP) card that is utilized to facilitate replaying data recorded at the recording system 150. The customer center 105 may have a switch 110 that includes one or more IP cards 610, 615. Such cards 610, 615 provide communications data to the recorders 650, 655 via a Virtual Local Area Network (VLAN) 620, respectively. Each recorder 650, 655 can communicate with the IP cards 610, 615 to replay the recorded data using contexts 1, 2, 3.

Each recorder 650, 655 can be configured to be assigned at least one identification code associated with at least one context to be recorded and replayed. The recorder 650, 655 can identify, record, and replay its assigned context by using the identification code. For example, the recorder 650 includes IP cards 630, 635, which are configured to facilitate replaying the recorded data using contexts 1 and 3, respectively. The recorder 655 can include an IP card 640, which is configured to facilitate replaying the recorded data using context 2. The recorder 655 further includes an IP 645, which communicates with other cards 630, 635, 640 and determines whether any of the other cards loses connection with the customer center 105. If the IP card 645 determines that a connection is lost, the IP card 645 takes over replaying the recorded data from the disconnected IP card. The IP cards 630, 635, 640, 645 can include, but are not limited to, network interface card (NIC) adapters and Internet Protocol switch interface (IPSI) cards, among others.

Multiple SPM sessions and replay sessions can occur in one context. In this example, phones 135A and 135B have IP cards 617, 619, respectively, and are assigned context 1. Each phone 135A, 135B can establish its own SPM session and replay session using context 1. The phones 135A, 135B can communicate directly to the recorders 650, 655 using the identification codes.

FIG. 7 is flow diagram that illustrates operation of an embodiment of the system 100, such as that shown in FIG. 1, that searches and replays data recorded at the recording system 150. In block 705, the computing device 115 and/or phone 135 receives security information to facilitate a user logging into a customer center's network. In block 710, the computing device 115 and/or phone 135 transmits request information to search and/or replay the data recorded at the recording system 150. Alternatively or additionally, the recording system 150 can store the request information so that a user can audit specific search request and specific replay request. In block 715, the recording system 150 determines whether the computing device 115 and/or phone 135 is authorized to search and replay the recorded data based on at least a portion of the request information. If the computing device 115 and/or phone 135 is not authorized, the recording system 150 denies the computing device 115 and/or phone 135 to search and replay the recorded data. In block 720, if the computing device 115 and/or phone 135 is authorized, the computing device 115 and/or phone 135 establishes a first session to search the data recorded at the recording system 150 and provide playback instructions.

In block 725, the recording system 150 determines whether the computing device 115 and/or phone 135 has selected and requested to replay the recorded data. If the computing device 115 and/or phone 135 does not select or request to replay the recorded data, the recording system 150 terminates the first session. In block 730, if the recording system 150 determines that the computing device 115 and/or phone 135 has selected and requested to replay the recorded data, the recording system 150 establishes a second session with the computing device 115 and/or phone 135 to replay the selected recorded data. Alternatively and additionally, the recording system 150 can use the first session to replay the recorded data to the computing device 115 and/or phone 135. Alternatively and additionally, the computing device 115 and/or phone 135 can provide an identification number, such as, a call back number, to the recording system 150, which can use to identification number to locate and establish the first session to replay the recorded data to the computing device 115 and/or phone 135.

In block 735, the recording system 150 replays the recorded data to the computing device 115 and/or phone 135 using the second session. Alternatively or additionally, the recording system 150 can encrypt and transmit the recorded data the computing device 115 and/or phone 135, which receives and decrypts the recorded data for replaying the recorded data. Alternatively or additionally, the computing device 115 and/or phone 135 can be configured to detect a replay session of the recorded data and prevent recording or storing of the replayed data on local memory, such as a computer hard drive and/or a phone's memory. Alternatively or additionally, the recording system 150 can instruct the computing device 115 and/or phone 135 not record or store the replayed data on the local memory.

In block 740, the recording system 150 determines whether the computing device 115 and/or phone 135 requested to forward, rewind, or pause the replay of the selected recorded data. If the request was not made, then the recording system 150 in block 745 determines whether the computing device 115 and/or phone 135 requested to stop the replay of the selected recorded data. If the request to stop the replay of the selected recorded data was made, the recording system 150 stops the replay of the selected recorded data. If the computing device 115 and/or phone 135 did not request to stop the replay of the selected recorded data, the process resumes back to block 735 to continue replaying the selected recorded data. If the computing device 115 and/or phone 135 requested the recording system 150 to forward, rewind, or pause the replay of the selected recorded data, the recording system 150 in block 750 forwards, rewinds, or pauses the selected recorded data accordingly. After forwarding, rewinding, or pausing the selected recorded data, the process continues to block 745, which was explained earlier.

FIG. 8 is a block diagram that illustrates an embodiment of each of the switch 110, computing device 115, application server 125, CTI 127, gateway 130, phone 135, and recording system 155, such as that shown in FIG. 1. Generally, in terms of hardware architecture, the electrical components 110, 115, 125, 130, 135, 155 can include a processor 802, memory 804, and one or more input and/or output (I/O) devices 806 that are communicatively coupled via a local interface 808. The local interface 806 can include, for example but not limited to, one or more buses or other wired or wireless connections. The local interface may have additional elements, which are omitted for simplicity, such as controllers, buffers (caches), drivers, repeaters, and receivers to enable communications.

Further, the local interface 808 may include address, control, and/or data connections to enable appropriate communications among the aforementioned components. The processor 802 may be a hardware device for executing software, particularly software stored in memory 804.

The memory 804 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 804 may incorporate electronic, magnetic, optical, and/or other types of storage media. Note that the memory 804 can have a distributed architecture, where various components are situated remote from one another, but can be accessed by the processor 802. Additionally, the memory 804 includes an operating system 810, as well as instructions associated with the electrical components 110, 115, 125, 130, 135, 155.

One should note that the flowcharts included herein show the architecture, functionality, and/or operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions (such as depicted in the flowcharts), can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiments without departing substantially from the spirit and principles of the disclosure. All such modifications and variations are intended to be included herein within the scope of this disclosure.

Therefore, at least the following is claimed:

1. A method for replaying recorded data, comprising the steps of:
instructing a recording system to replay recorded data to at least one of a phone and a computing device;
establishing a first session to replay the recorded data over a network, the first session including an electrical connection to facilitate communication between the recording system and the at least one of the phone and the computing device; and
replaying by the recording system the recorded data to the at least one of the phone and the computing device using the established first session.

2. The method as defined in claim 1, wherein the first session is configured to facilitate communication between the recording system and the at least one of the phone and the computing device using at least one of a session initiation protocol (SIP), real-time transport protocol (RTP) and Pseudowire Emulation Edge to Edge (PWE3) protocol.

3. The method as defined in claim 1, wherein the recorded data includes media data and meta data associated with the recorded data, the media data including at least one of audio, text, and video, the meta data including at least one of automatic number identification (ANI), dialed number identification service, and called party information.

4. The method as defined in claim 1, further comprising:
receiving security information to facilitate a user logging into a customer center's network.

5. The method as defined in claim 1, further comprising transmitting request information to search or replay the data recorded at the recording system.

6. The method as defined in claim 5, further comprising storing the request information so that a user can audit specific search request and replay request.

7. The method as defined in claim 5, further comprising determining whether the at least one of the phone and the computing device is authorized to search or replay the recorded data based on the request information.

8. The method as defined in claim 7, further comprising responsive to determining that the at least one of the phone and the computing device is authorized, searching the data recorded at the recording system using at least one of the established first session, a second session, a proprietary protocol, and a webserver.

9. The method as defined in claim 8, wherein searching the data recorded at the recording system uses at least one of a session initiation protocol (SIP), real-time transport protocol (RTP) and Pseudowire Emulation Edge to Edge (PWE3) protocol.

10. The method as defined in claim 9, wherein searching the data recorded at the recording system uses the SIP between the recording system and at least one of a switch, gateway, computer telephony integration, and application server, and replaying the recorded data uses the PWE3 between the at least one of the phone and the computing device and the at least one of the switch, gateway, computer telephony integration, and application server.

11. The method as defined in claim 1, further comprising instructing the recording system to perform at least one of forwarding, rewinding, and pausing the replay of recorded data using at least one of the established first session, a second session, a proprietary protocol, and a webserver.

12. The method as defined in claim 1, wherein replaying the recorded data comprises:
encrypting the recorded data by the recording system; and
decrypting the recorded data by the at least one of the phone and the computing device.

13. The method as defined in claim 1, further comprising instructing the at least one of the phone and the computing device not to record or store the replayed data on local memory.

14. A system for replaying recorded data comprising:
at least one of a phone and a computing device being configured to instruct a recording system to replay recorded data; and
a recording system being configured to communicate with the at least one of the phone and the computing device, the recording system being further configured to facilitate establishing a session to replay the recorded data, the recording system being further configured to replay the recorded data to the at least one of the phone and the computing device using the established session.

15. The system as defined in claim 14, wherein the at least one of the phone and the computing device is configured to receive security information to log into the at least one of the phone and the computing device and log a user into the at least one of the phone and the computing device based on the received security information.

16. The system as defined in claim 14, wherein the at least one of the phone and the computing device is configured to transmit request information to search or replay the recorded data at the recording system.

17. The system as defined in claim 16, wherein the recording system is further configured to determine whether the at least one of the phone and the computing device is authorized to search or replay the recorded data based on the request information.

18. The system as defined in claim 17, wherein responsive to determining that the at least one of the phone and the computing device is authorized, the recording system is further configured to facilitate establishing a second session to search the data recorded at the recording system.

19. The system as defined in claim 18, wherein the at least one of the phone and the computing device is further configured to instruct the recording system to perform at least one of forwarding, rewinding, and pausing the replay of recorded data using the second session.

20. The system as defined in claim 19, wherein the recording system is further configured to encrypt the recorded data.

21. The system as defined in claim 20, wherein the at least one of the phone and the computing device is further configured to decrypt the encrypted recorded data for replaying the recorded data.

22. The system as defined in claim 14, wherein the at least one of the phone and the computing device is further configured to not record or store the replayed data on local memory.

23. The system as defined in claim 14, further comprising at least one of a switch, gateway, computer telephony integration and application server that is configured to receive information from at least one of the phone, the computing device and the recording system, and perform at least one of network address translation (NAT), session and media routing, and transcoding between the at least one of the phone and the computing device and the recording system.

24. A system for replaying recorded data comprising:
at least one of a switch, application server, computer telephony integration, and gateway configured to transmit request information to search or replay the data recorded at the recording system; and
a recording system configured to communicate with the at least one of the switch, the application server, the computer telephony integration, and the gateway, the recording system being further configured to facilitate establishing a session to replay the recorded data to at least one of a phone and a computing device.

25. The system as defined in claim 24, wherein the at least one of the switch, the application server, the computer telephony integration, and the gateway is further configured to facilitate establishing a second session to search the data recorded at the recording system.

26. The system as defined in claim 24, wherein the at least one of the phone and the computing device is further configured to instruct the recording system to perform at least one of forwarding, rewinding, and pausing the replay of recorded data using at least one of the established first session, a second session, a proprietary protocol, and a webserver.

27. The system as defined in claim 24, wherein the recording system is further configured to encrypt the recorded data and transmit the encrypted recorded data, and the at least one of the phone and the computing device is further configured to receive and decrypt the encrypted recorded data for replaying the recorded data.

28. The system as defined in claim 24, wherein the at least one of the phone and the computing device is further configured to not record or store the replayed data on local memory.
